(19) United States
(12) Patent Application Publication
(10) Pub. No.: US 2026/0219880 A1
(43) Pub. Date: Jul. 30, 2026

(54) AUTOMATIC CODE REFACTOR WITH ABSTRACT SYNTAX TREE AND GENERATIVE AI

(71) Applicant: Intuit Inc., Mountain View, CA (US)

(72) Inventor: Long H. LE, San Jose, CA (US)

(21) Appl. No.: 19/039,927

(22) Filed: Jan. 29, 2025

(51) Int. Cl. G06F 8/72; G06F 8/41; G06F 8/60

(52) U.S. Cl. CPC G06F 8/72; G06F 8/427; G06F 8/4435; G06F 8/60

(57) ABSTRACT

Certain aspects provide a computer-implemented method for automatically refactoring source code according to a target condition. The method includes identifying a current condition and a source code snippet from the source code of a software application. A context file and a tokenized file are generated based on the source code. A context file segment that corresponds to the source code snippet is identified from the context file. A refactoring prompt configured to cause a language model (LM) to refactor source code according to a target condition is generated and provided, along with the context file segment to the LM as input. A refactored source code snippet comprising at least one logic statement in the source code snippet that is modified according to the target condition using the context file segment and the refactoring prompt is received from the LM. A final refactored source code is then generated.

### BACKGROUND

### Field

Aspects of the present disclosure relate to systems and methods for automatically refactoring source code using artificial intelligence (AI).

### Description of Related Art

Computer code refers to the set of computing programming instructions that instructs a computer on what actions to perform. Computer code can instruct a computer to store and organize data, run software applications, display data to a user, perform mathematical calculations, among many other tasks. Thus, computer code forms the foundation of modern software applications.

There are several different types of computer code that are used in computer programming, including executable code, object code, assembly code, machine code, and source code. Executable code refers to the final code package that can be run by an operating system and combines multiple object files and libraries, as well as program headers, and other metadata that the operating system needs to run the package. Object code is compiled code and contains machine code but needs to be linked with other files to be executable by the processor. Assembly code refers to a lower-level version of machine code that is still human-readable. Machine code is configured as raw binary instructions and can be executed by a processor directly. However, because of the binary nature of machine code, computer programmers do not write machine code directly. Instead, developers will write source code that is later transformed into machine code.

Source code is a human-readable and text-based form of computer programming instructions. Source code is written in high-level programming languages, such as Java, Python, and C++, and provides abstract instructions that can be converted into machine code through compilation or interpretation. These abstract instructions are directed to logic, algorithms, and structures that define a software application's behavior. In addition to writing new source code, developers often need to modify and improve source code to maintain software quality, enhance performance, and add new features.

While the format of source code and the development of different high-level programming for writing source code has led to a more human-readable and user-friendly format of computer code, technical problems still arise with writing and especially modifying source code. For example, when application functionality grows in complexity, the foundational source code also evolves and becomes more complex and more difficult to modify and maintain because of the increased amount of code, dependencies and cross-references within the code, as well as more complicated and hierarchal architecture of code files.

### SUMMARY

Certain aspects provide a computer-implemented method for automatically refactoring source code according to a target condition. The method includes identifying a current condition of a source code, the source code being associated with a software application; identifying a source code snippet from the source code, the source code snippet associated with the current condition of the source code; generating a context file and a tokenized file based on the source code; identifying a context file segment that corresponds to the source code snippet from the context file; generating a refactoring prompt configured to cause a language model (LM) to refactor source code according to a target condition that is a modification of the current condition of the source code; providing the context file segment and the refactoring prompt as input to the LM; receiving, from the LM, a refactored source code snippet comprising at least one logic statement in the source code snippet that is modified according to the target condition using the context file segment and the refactoring prompt; and generating a final refactored source code by replacing a token corresponding to the source code snippet in the tokenized file with the refactored source code snippet the final refactored source code reflecting the target condition.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example of an excerpt from a current version of source code and an example of a final refactored version of the source code.

FIG. 2 depicts a process flowchart for automatically refactoring source code using a code splitter, an LLM, and a combiner.

FIG. 3 depicts a process flowchart for using the code splitter to parse source code, generate an abstract syntax tree, and identify code snippets that need to be refactored.

FIG. 4 depicts an example of a code snippet that has been identified from a current version of the source code.

FIG. 5 depicts a process flowchart for using the code splitter to generate a context file and a tokenized file from the source code.

FIG. 6 depicts an example of a context file and an example of a tokenized file generated from the source code.

FIG. 7 depicts a process flowchart for using an LLM to generate refactored code snippets based on a refactoring prompt, a context file segment, and a code snippet identified from the source code that will be refactored.

FIG. 8 depicts an example of a refactored code snippet based on the context file segment and a refactoring prompt.

FIG. 9 depicts a process flowchart for using a combiner to generate a final refactored source code based on the refactored code snippet and tokenized file.

FIG. 10 depicts an example of final refactored source code generated from the refactored source code snippet and tokenized file being combined.

FIG. 11 depicts a method for automatically refactoring source code.

FIG. 12 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

There are many different circumstances in which source code needs to be modified. For example, when a new functionality of an application is desired, new source code must be written and added into the existing code base (e.g., in files). Similarly, when a particular function is no longer desired, certain sections and logic of the source code will need to be deleted and other sections that were affected by the deletion (e.g., dependencies) will also need to be modified. In some instances, existing source code needs to be modified while maintaining the functionality of the code. This modification process, also known as refactoring, involves restructuring existing code without changing its intended behavior.

Refactoring becomes necessary when code complexity increases, performance degrades, or technical debt accumulates (i.e., the implied cost of additional rework that is caused when developers write code that is the faster to write and implement, but not necessarily better, for implementing a particular functionality of the code). For example, an initial script could be written to add a new feature into the source code of an application where that initial script is fast to write and implement into the existing code. However, the initial script may be clunky or use excess computational resources during run-time as compared to another version of the script that takes longer to write and implement but utilizes less computational resources over the long-term of compiling and executing the source code. Another common scenario requiring refactoring involves the removal of obsolete feature flags. Feature flags, also known as feature toggles, are conditional statements in source code that enable or disable specific functionality based on different configuration settings. These feature flags allow developers to deploy new features gradually, conduct A/B testing, or manage different versions of functionality. However, feature flags can become obsolete when functionalities are permanently abandoned, tests are completed, corresponding features are fully deployed, etc. For example, a feature flag controlling the rollout of a new user interface component becomes unnecessary once the component is fully deployed to all users.

Typically, refactoring is performed manually by developers. When performing manual refactoring, developers must carefully trace flag dependencies, update affected code paths, and ensure that removing conditional statements does not introduce new bugs or unintended behavior. The complexity of refactoring increases exponentially in distributed systems where feature flags may influence service interactions and data flow patterns across a large code base and many different code files. Furthermore, even when code snippets related to the feature flag are correctly identified, errors can still occur during the actual modification of the code snippets when working to produce the final refactored code. Because of these factors, manual refactoring can be a very time-consuming and error-prone process, particularly in large codebases where feature flags may be referenced across multiple files and functions.

Other technical problems arise when refactoring the source code to produce the final version of the entire source code for an application. For example, if the existing text of the source code is modified directly in the original source code file, significant computational resources are expended, including extensive memory used for storing the entire contents of the source code files as well as large amounts of processing (compute) required to process all of the source code files during the refactoring process. In some instances, conventional systems have attempted to isolate portions of the existing code and refactor in a piece-wise methodology (e.g., limited snippets at a time). However, integrating the modified code snippets back into the source code files can be challenging when trying to identify the correct location to add or replace the modified code snippet, leading to a flawed final refactored source code file.

When code is refactored improperly, such as when logic statements are missed, incorrectly modified, or incorrectly reintegrated during refactoring, system behavior can be disrupted because of defects introduced into the code. This can cause unwanted system behavior that degrades a user experience with the software applications or increases the amount of computational resources (e.g., processing and memory) that is needed to run the application. In some instances, the defects introduced by a flawed refactoring can lead to compilation or other related application failures, which then incurs additional resources, such as time, money, and computational resources needed to fix these new errors. Additionally, often these errors do not arise until compilation and/or run-time of the code, which leads to wasted computational resources being used to deploy failed compilations and failed runs. All of these aforementioned issues can lead to downtime of an application, which causes significant setbacks for users and companies who rely on the software applications for their own downstream tasks.

Software developers have attempted to address these problems with manual refactoring through various methods. For example, integrated development environments (IDEs) offer automated refactoring tools that can identify and modify code patterns. Additionally, version control systems help track and manage code changes during refactoring. Static analysis tools attempt to detect unused code and identify potential issues.

However, these solutions still present significant limitations. For example, these tools may miss complex flag dependencies, especially when automated systems are based on strict syntax matching and rule-based analysis to identify those flag dependencies. Conventional automated approaches to refactoring can miss feature flags and their dependencies because feature flags often interact with configuration settings stored in multiple formats and locations, such as environment variables, database entries, and distributed configuration systems. Flag values might be passed through multiple layers of function calls, stored in object properties, or transformed through complex Boolean operations that conventional automated tools struggle to track. Additionally, feature flags can have dependencies where one flag's state affects the behavior of other flags through shared logic or data flow patterns. Thus conventional systems and methods for refactoring experience difficulty in detecting these relationships without a deeper understanding of the application's domain logic.

Accordingly, aspects of the present disclosure provide apparatuses, methods, processing systems, and computer-readable mediums for automatically refactoring source code to overcome the aforementioned technical problems. In particular, the present disclosure is directed to an automatic code refactoring process that utilizes generative artificial intelligence (AI) to achieve a deeper understanding of the application's logic and to better identify feature flag dependencies to produce a more accurate and error-free refactored source code.

Generative artificial intelligence (GenAI) refers to machine learning models that are able to create new content based on patterns and information learned from training data. Some GenAI models are configured as language models (LMs). An LM is generally a type of machine learning model that is designed to understand, generate, and manipulate human language as presented in text-based format. More specifically, an LM is a probabilistic framework that determines the likelihood of a sequence of words or tokens. At its core, a LM attempts to predict the probability of the next word in a sentence given the preceding words. LMs are useful in natural language processing (NLP) and computational linguistics for performing a range of tasks involving human language. LMs are adept at understanding context and identifying patterns and hierarchies.

To facilitate text generation and modification, a user provides a prompt that instructs the model on what content to generate. Notably, in some instances, the content generated can actually be a modification or restructuring of existing content that is provided as additional input to the model. However, while a powerful tool, the outputs of a general-purpose LM may be highly sensitive to the contents and structure of the prompt used to instruct the LM to perform the specified task, leading to hallucinations and other inaccuracies in the outputs. In the context of language models, a hallucination occurs when the model generates content that is false, misleading, or ungrounded in reality, but presents it as factual information. This phenomenon may occur when an LM produces outputs that are not based on its training data or are incorrectly decoded, resulting in nonsensical or inaccurate responses.

Accordingly, aspects of the present disclosure are directed to a system comprising a code splitter, an LM, and a combiner that are utilized in series to leverage the expansive capabilities of GenAI while mitigating the possibility of hallucinations and inaccuracies arising in refactored code generated by the LM. This is achieved by prompt engineering, including structuring of existing code to be modified as well as extracting relevant context to be provided as inputs to the LM. The outputs of the LM (e.g., refactored code sections) are also integrated back into the rest of the source code in an organized and efficient manner to help produce a final refactored code that is ready to be compiled and executed. It should be appreciated that while the following description is focused on the application of removing obsolete feature flags during refactoring, the present disclosure can be utilized in any application where source code files need to be modified (e.g., removing an obsolete feature flag, implementing a new functionality, identifying and fixing bugs, etc.).

For example, to facilitate the restructuring of existing code and to provide additional context to the LM, the code splitter is configured to perform various beneficial functions. For example, the code splitter is configured to parse the source code file into discrete logic statements so that an abstract syntax tree (AST) can be created to represent the source code file. An abstract syntax tree is a data structure used to represent the structure of a computer program. It is a tree representation of the abstract syntactic structure of text (i.e., source code) written in a high-level computer programming language.

Additionally, the code splitter is configured to generate a context file and a tokenized file from the source code file. A context file is a version of the source code that includes additional context to the existing lines of code, for example, labels such as start and stop indicating the beginning and end of certain logic sections, and other notes that can be used by the LM when refactoring a code snippet. A tokenized file contains tokens in place of extracted content from the source code file. A token is configured as a line of code that acts a label for a longer section of code.

Next, source code snippets identified from the abstract syntax tree are used to identify corresponding context file segments from the context file. A context file segment includes the code snippet as well as additional context to the code snippet, such as surrounding lines of code and additional notes and labels that can be used by the LM to refactor the code snippet accurately. A refactoring prompt configured to cause the LM to refactor the source code snippets using the context file segments are provided to the LM, along with the corresponding context file segment. The LM then outputs a refactored source code snippet. In some instances, the LM is configured as a large LM (e.g., LLM) which is generally characterized by a relatively large number of trainable parameters (e.g., billions of model parameters) and large amounts of training data used to train the LLM.

Finally, the refactored source code snippet and the tokenized file are provided to the combiner. The combiner is configured to integrate the refactored source code snippet back into the source code using the tokenized file and output the final refactored source code. This process is repeated for all source code snippets that were identified from the parsed source code/abstract syntax tree so that the final refactored source code is completely refactored.

Accordingly, by employing a system including a code splitter, an LM, and a combiner, as described herein, the present disclosure achieves many technical benefits over the state of the art in providing technical solutions to technical problems associated with refactoring source code. For example, the present disclosure overcomes the technical problem of incomplete identification of code snippets related to the obsolete feature flag. This is achieved by first converting the source code into an abstract syntax tree, wherein logic statements related to the obsolete feature can be more accurately and efficiently identified. Furthermore, additional logic statements that are dependent on states of logic statements related to the obsolete feature flag can also be quickly and easily identified because of the hierarchal nature of the AST which maps out dependencies between code snippets as interconnected nodes.

The present disclosure overcomes the technical problem of flawed modification as part of the refactoring process by beneficially leveraging the understanding and generation capabilities of LMs as well as providing specially configured inputs to help prevent any hallucinations that might have been produced by the LM. For example, by generating a context file from the source code, specific portions of the context file are able to be identified as corresponding to a particular code snippet that needs to be refactored. By providing context such as code lines surrounding the particular code snippet and additional labels and notes that can be used by the LM, the LM is able to accurately modify the particular code snippet based on providing the context file segment of the context file corresponding to the code snippet and the refactoring prompt to the LM.

The present disclosure also overcomes the technical problems arising from flawed integration of individual code snippets back into the source code files. By generating a tokenized file from the source code, each section of the source code is simplified to an individual token (e.g., label). This greatly reduces the memory required to store and processing resources required to process the source code file when identifying the correct location to integrate the newly refactored code snippet. Not only are computational resources reduced, the time is also reduced for finalizing the refactored source code files because it is easier and more efficient to identify a single token and replace the token with the newly refactored code snippet than search an entire source code file and identify all of the related lines of code that need to be replaced.

All of the aforementioned technical solutions beneficially prevent errors from being introduced into the final refactored source code. By preventing errors, aspects of the present disclosure are then able to prevent waste of computational resources that would have been needed to either compile or run the flawed source code and/or to fix the errors. Overall, by providing a more accurate refactored source code, the user experience and/or downstream applications interacting with the current application corresponding to the source code is improved.

### Example of Automatically Refactored Source Code

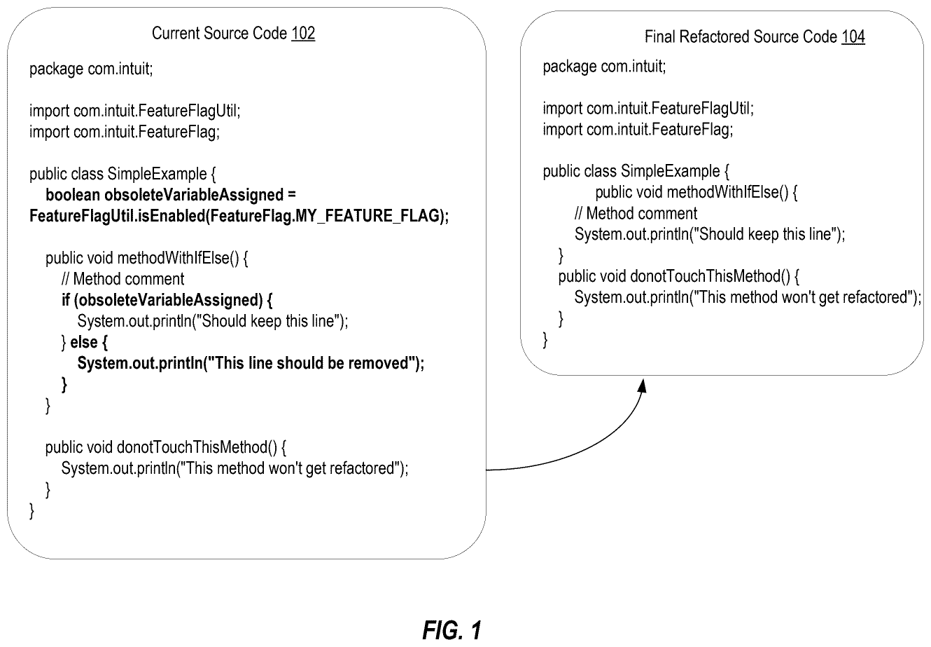

FIG. 1 depicts an example of an excerpt from a current version of source code corresponding to a current condition of the source code and an example of a final refactored version of the source code corresponding to a target condition of the source code.

In particular, FIG. 1 depicts current source code 102 and final refactored source code 104. Current source code 102 and final refactored source code 104 comprise lines of source code that can be compiled and deployed to facilitate various functionalities of a software application. Final refactored source code 104 is the final refactored version of current source code 102, which may be an original version of the source code, a most recent version of the source code, or another intermediate modified version. Current source code 102 includes a package identification (e.g., “package com. intuit”) and declares that the class belongs to that named package to help organize code and prevent naming conflicts. Current source code 102 also includes code lines for importing two classes that will be used in the code: “FeatureFlagUtil” and “FeatureFlag.” Current source code 102 also defines a public class (e.g., “SimpleExample”) that other classes will be able to access.

Within the defined public class, a Boolean variable (e.g., “obsoleteVariableAssigned”) is created that checks to see if a specific feature flag (“MY_FEATURE_FLAG”) is enabled using the FeatureFlagUtil class. Next, a public method (e.g., “methodWithIfElse”) is declared and further includes a block that has a comment (e.g., “//Method comment”). This public method checks the value of the Boolean variable. If the value is true, the method is configured to print a string (e.g., “Should keep this line”). If the value is false, the method is configured to print a different string (e.g., “This line should be removed”). These if-else statements are a type of logic statement that help control program flow by making decisions based on whether previously defined conditions are true or false. Current source code 102 also includes another method (e.g., “donotTouchThisMethod”) that does not have a conditional statement and prints out a string: “This method won't get refactored”).

Notably, current source code 102 shows an example of source code that demonstrates feature flag usage and, for illustrative purposes, indicates which parts of the code (e.g., bolded lines of text) will be modified or removed during the refactoring process and which parts of the code (e.g., non-bolded lines of text) that will be left unchanged. Notably, in the example of removing obsolete feature flags, while the definition of the feature flag will be removed, the import of the feature flag may not be modified or removed because it may contain other feature flags that are not obsolete. The source code is analyzed across all available source code files to identify and refactor code that references the feature flag. Accordingly, final refactored source code 104 reflects a refactored version of current source code 102 that has been refactored according to the target condition by removing an obsolete feature flag. By refactoring the source code in this manner, the computer program no longer relies on whether “FeatureFlagUtil” is enabled or not.

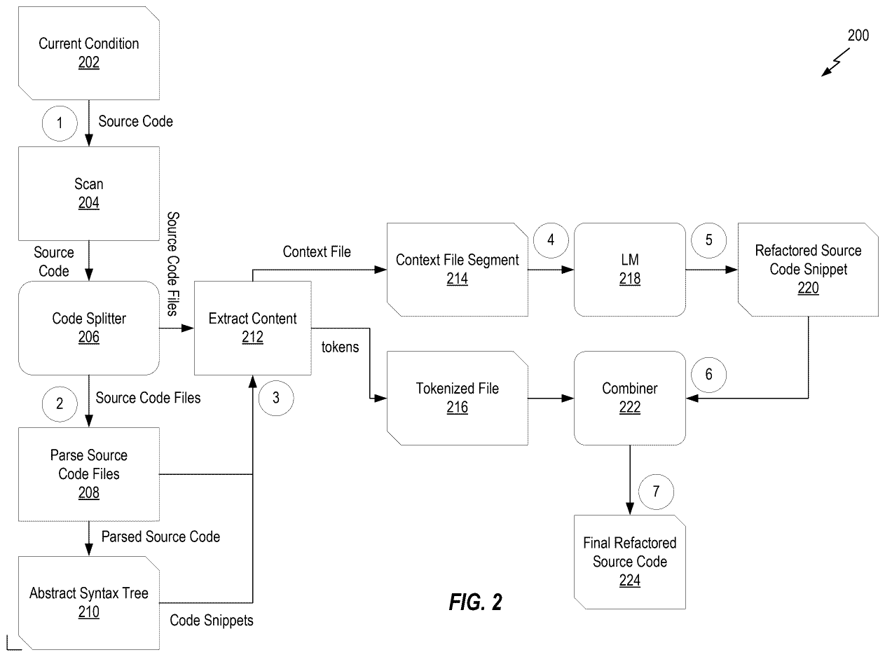

Thus, as shown in FIG. 1, final refactored source code 104 has been modified to omit lines of code that relate to the obsolete feature flag. Specifically, the logic statement that determined program behavior on whether the feature flag was enabled or not has been removed. Accordingly, the first public method now is no longer dependent on the state of the feature flag and will always print out “Should keep this line.” Additionally, as desired, the second public method remains unchanged because it did not reference the obsolete feature flag. Current source code 102 can be automatically refactored in this manner to generate final refactored source code 104 using systems and methods described herein with respect to FIGS. 2-12.

### Process Flowcharts for Automatically Refactoring Source Code

FIG. 2 depicts a process flowchart 200 for automatically refactoring source code using a code splitter, an LLM, and a combiner. The source code comprises one or more lines of code that correspond to a current condition 202 of the source code. A target condition is a modified version of the current condition 202. In some instances, current condition 202 is automatically identified by a computing system and/or machine learning model configured to monitor conditions of the source code. In some instances, current condition 202 is identified based on user input (e.g., a target condition) that is received indicating how the source code should be changed, such that the source code is scanned for usage of code that does not presently meet the target condition. In the example of refactoring the source code to remove obsolete feature flags, a current condition 202 of the source code is the presence of at least one obsolete feature flag and a target condition is the omission of the obsolete feature flag, wherein the refactoring process includes removing the obsolete feature flag and any dependencies referencing the obsolete feature flag. It should be appreciated that examples described herein relate to obsolete feature flags, the systems and methods described herein can be used to modify source code from any current condition to any target condition.

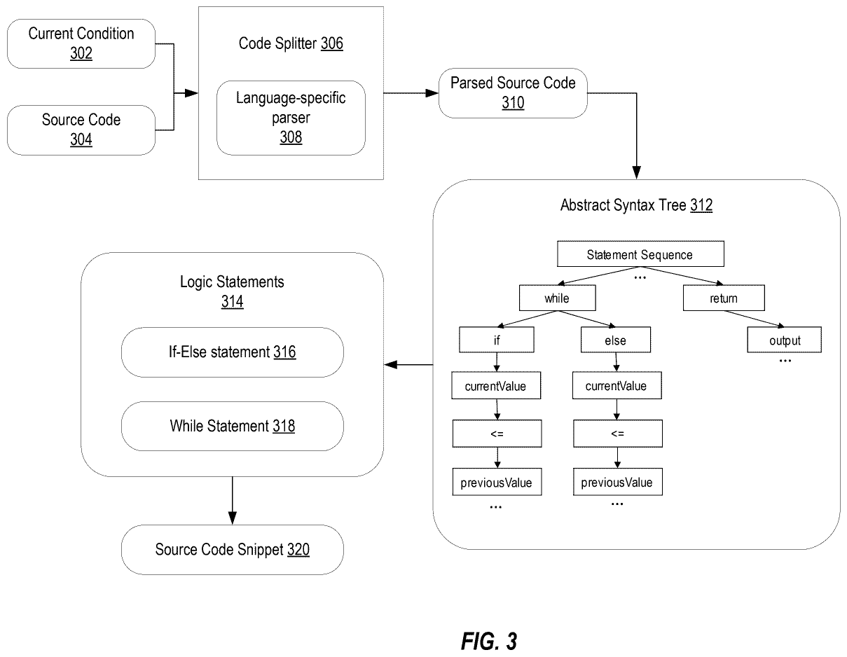

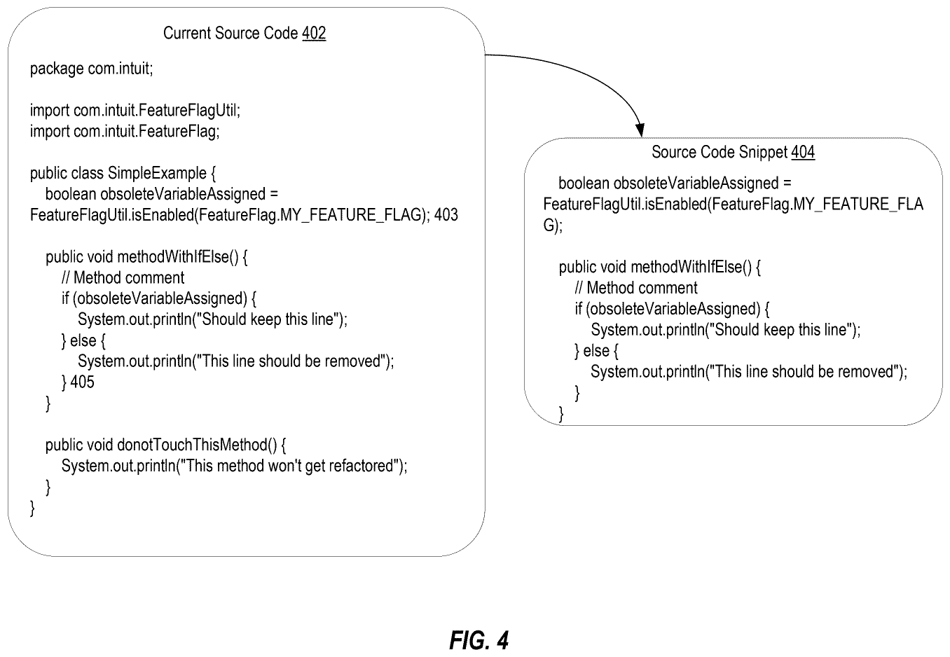

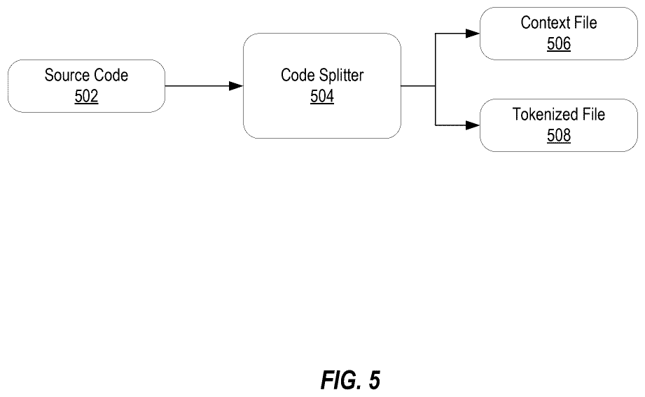

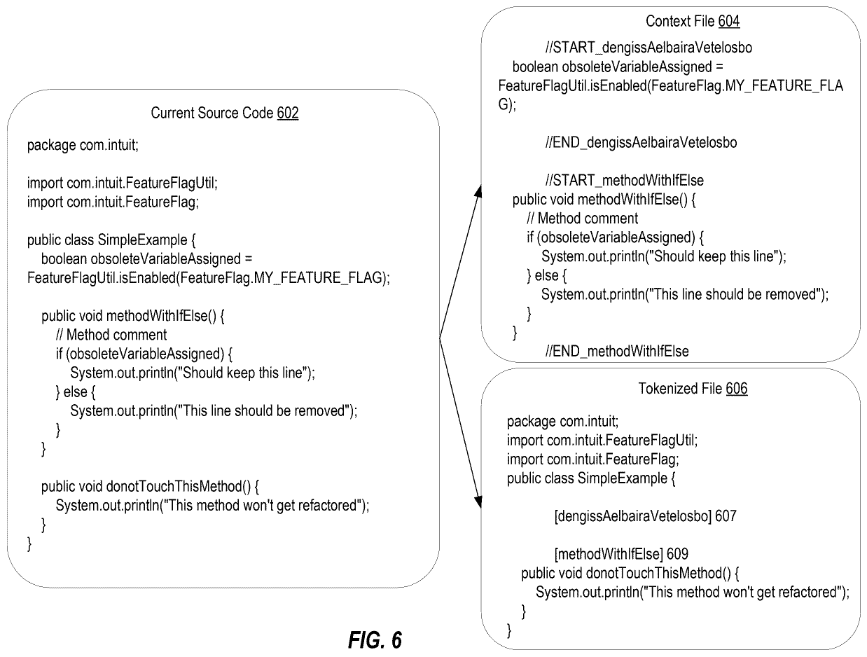

The source code is then scanned at 204 for code lines that reference and/or are related to current condition 202. Code splitter 206, described in more detail with reference to FIGS. 3-4, is configured to parse the source code files (e.g., parse source code files 208) into parsed source code and generate abstract syntax tree 210. Abstract syntax tree 210 is then analyzed and used to identify one or more code snippets from the source code that relate to the current condition 202. Code splitter 206, described in further detail with reference to FIGS. 5-6, is configured to extract content 212 from the source code files and generate a context file and tokenized file 216. As noted above, a context file is a version of the source code that includes additional context to the existing lines of code, for example, labels such as start and stop indicating the beginning and end of certain logic sections, and other notes that can be used by the LM when refactoring a code snippet. A tokenized file contains tokens in place of extracted content from the source code file. A token may be configured as a line of code, a numeric representation, or a series of characters, such as a word or phrase, where the token acts a label for a longer section of code.

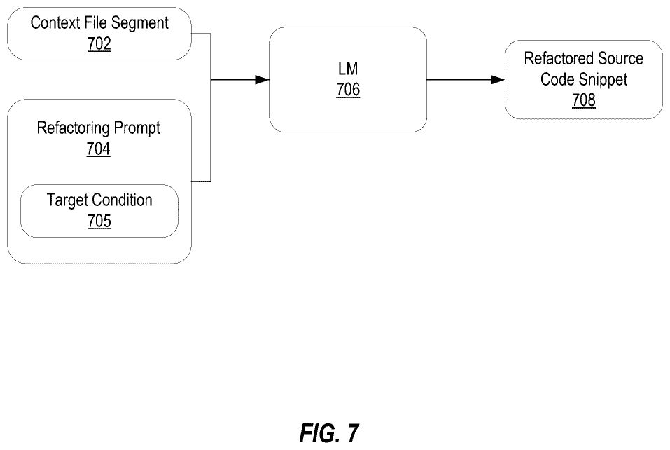

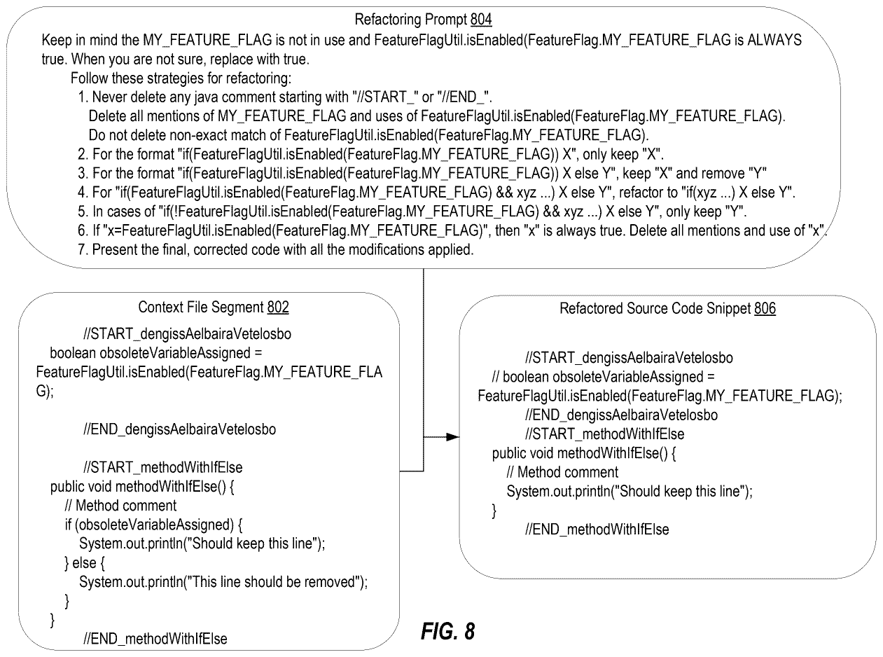

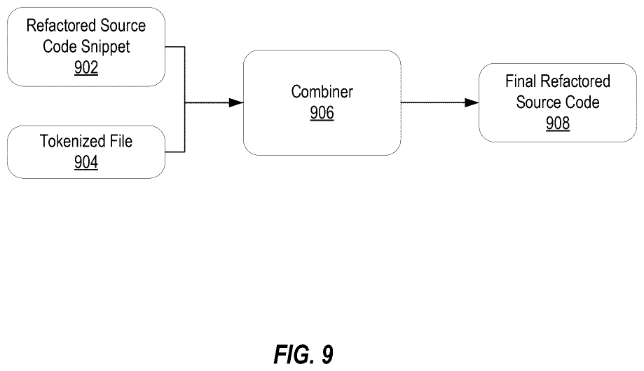

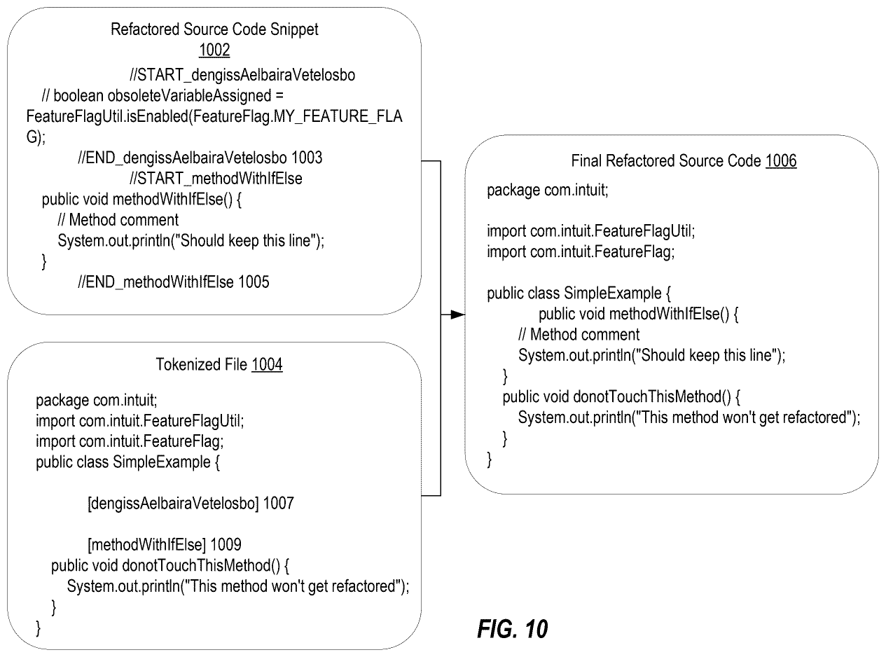

Context file segment 214 is selected from the context file based on context file segment 214 corresponding to the code snippet related to current condition 202. A context file segment comprises a limited excerpt of the context file. Context file segment 214 is then provided to LM 218 to generate refactored source code snippet 220, a process described in more detail with reference to FIGS. 7-8. Finally, refactored source code snippet 220 and tokenized file 216 are combined by combiner 222 to generate final refactored source code 224, a process described in more detail with reference to FIGS. 9-10.

### Process Flowcharts for Generating Abstract Syntax Trees

FIG. 3 depicts a process flowchart for using code splitter 306 (like code splitter 206 of FIG. 2) to parse source code 304, generate abstract syntax tree 312 (e.g., abstract syntax tree 210), and identify source code snippet 320 that needs to be refactored according to a target condition modified from a current condition 302 of the source code.

Code splitter 306 is configured to parse source code 304. The language-specific parser 308 takes the source code 304 as input and analyzes the code structure according to the language grammar. In some instances, code splitter 306 utilizes a language-specific parser 308 selected based on a particular programming language in which source code 304 is written. For example, one language-specific parser 308 could be selected for C++ and another for Java™. Accordingly, code splitter 306 may have access to a plurality of different language-specific parsers for a variety of different programming languages, one or more of which may be associated with different source code files that need to be refactored. In some instances, code splitter 306 utilizes a universal-language parser that is configured to parse code written in one or more programming languages.

Based on the parsed source code 310, abstract syntax tree 312 can be generated. In some aspects, abstract syntax tree 312 is generated by applying grammar rules corresponding to the language in which the source code is written to parsed source code 310 to create a hierarchal tree structure. The parser will group parsed source code segments into expressions and enforce syntax rules to generate a plurality of nodes that represent different code constructs found in the parsed source code.

Accordingly, abstract syntax tree 312 is a tree data structure (e.g., a hierarchical structure wherein nodes are organized in a parent-child relationship) that represents the syntactic structure of source code. Each node in the tree represents a language construct, with a root node representing the entire program. Abstract syntax tree 312 thus mirrors the nested structure of the source code. Each node in abstract syntax tree 312 has a specific node type that corresponds to different language constructs, like variables, operators, function declarations, and control flow statements. In some instances, abstract syntax tree 312 also maintains a symbol table that tracks variable scopes, types, and other semantic information. The symbol table can be used to validate type checking and name resolution during the refactoring process.

By generating abstract syntax tree 312, feature flags and their dependencies can be easily tracked using the data flow represented by abstract syntax tree 312 because the relationships between different parts of the code become more apparent. For example, complex logic expressions can be broken down into simpler, nested expression components. Accordingly, a feature flag and its dependencies create easily identifiable branches in abstract syntax tree 312, where a first definition of the feature flag is represented by a first node which then branches into different nodes representing different dependencies on the state of the feature flag. This sub-tree that has a conditional node references the feature flag can then be extracted, wherein discrete logic statements can be identified.

Abstract syntax tree 312 may generally be language-independent, meaning that downstream aspects of the refactoring process, including identifying and extracting code snippets from the source code based on abstract syntax tree 312, can be used for any programming language corresponding to the original source code. For example, code written in Java language would need a semi-colon at the end of a statement, whereas code written in Python may not need a punctuation identifier, which then may be harder to identify feature flags and their dependencies. However, with the help of abstract syntax tree 312, the correct code snippet can be properly identified because the if-then statement in either language would be represented by the same node arrangement in the corresponding abstract syntax tree.

Based on abstract syntax tree 312 and current condition 302, logic statements 314 can be identified as being related to current condition 302. Logic statements 314 can comprise any number of logic statements, for example, if-else statement 316 and while statement 318. There are many different types of logic statements, including if-else statements, while statements, Boolean variables, etc. Logic statements 314 can be refactored to reflect a new target condition. As an example, in the case of removing obsolete feature flags, logic statements 314 may reference an obsolete feature flag, including dependencies on the obsolete feature flag. Based on identifying a logic statement that references the obsolete feature flag using abstract syntax tree 312, source code snippet 320 is identified in the source code as corresponding to the logic statement. Source code snippet 320 includes the logic statement as well as surrounding lines of code that are relevant to executing the logic statement.

FIG. 4 depicts an example of a source code snippet 404 that has been identified from a current version of the source code based on an abstract syntax tree. Current source code 402 is representative of current source code 102 depicted in FIG. 1. Source code snippet 404 (which may be an example of source code snippet 320 of FIG. 3) comprises a section of current source code 402. In particular, source code snippet 404 comprises source code lines that references the obsolete feature flag (e.g., obsolete feature flag 403), including the if-else statement that references the obsolete feature flag (e.g., if-else statement 405). Notably, the if-else statement 405 is identified using an abstract syntax tree. For example, when the abstract syntax tree is generated, conditions surrounding the obsolete feature flag are structured as nodes under a sub-tree corresponding to the obsolete feature flag. All the nodes in the abstract syntax tree are scanned to identify one or more “sub-trees” that reference the obsolete feature flag. The sub-trees are then extracted from the abstract syntax tree and further analyzed to identify discrete logic statements, such as if-else statement 405 based on the sub-tree node architecture. These logic statements correspond to a particular source code snippet, like source code snippet 404.

Source code snippet 404 further comprises additional lines of code that surround the if-else statement, including the Boolean variable declaration and the public method declaration. Source code snippet 404 is then used to identify a context file segment from a context file, which is described in more detail below.

### Process Flowcharts for Generating Context and Tokenized Files

FIG. 5 depicts a process flowchart for using code splitter 504 (which may be an example of code splitter 306 of FIG. 3) to generate context file 506 and tokenized file 508 (which may be an example of tokenized file 216 of FIG. 2) from source code 502 (which may be an example of source code 304 of FIG. 3).

Context file 506 is a modified version of source code 502, where additional context to the existing lines of code has been added as comments throughout the file. Notably, these comments are not executable by a processing system but can be read and understood by an LM (e.g., LM 218). The comments act as labels, such as starting points and ending points of different sections of code, which can help an LM to identify the start and stop of a logic statement, method declaration, or variable declaration. Tokenized file 508 is a tokenized version of source code 502 and comprises a plurality of tokens. Each token represents one or more related lines (or partial lines) of source code 502. In some instances, a token is configured as string-based label that represents the line(s) of code.

In aspects, only lines of code that reference the obsolete feature flag are tokenized. For example, for each source code snippet that is extracted from a source code file, code splitter 504 replaces the extracted source code snippet with a token in the corresponding source code file. Beneficially, this helps to facilitate a targeted refactoring process in which only those portions of code that need to be refactored are extracted and subsequently modified. Thus, by replacing the source code snippet with a token, other portions of the source code file will remain untouched, thereby reducing the opportunity for errors to be introduced into the other portions of the source code file.

Accordingly, each extracted source code snippet that will be refactored has a 1-1 relationship with a corresponding token in the source code file. In this manner, the refactored code snippet and tokenized file can be easily combined because the refactored source code snippet can be easily matched to its corresponding token in the source code file, as will be described in more detail with respect to FIG. 9.

In this manner, context file 506 may be generated in parallel with tokenized file 508 because when source code snippets are extracted from a particular source code file and a token is generated in its place, the extracted source code snippets are placed into context file 506. Thus, in some aspects, context file 506 only comprises the extracted source code snippets (and related contextual comments to the source code snippets as described above) from a particular source code file. Notably, when there are multiple source code files that need to be refactored, each source code file will have a corresponding context file comprising one or more source code snippets extracted from the corresponding source code file.

FIG. 6 depicts an example of a context file 604 and an example of a tokenized file 606 generated from the source code.

Current source code 602 is reproduction of current source code 402 in FIG. 4 and is also representative of source code 502 in FIG. 5. Context file 604 (e.g., context file 506) comprises additional comments that mark the start (e.g., “//START_dengissAelbairaVetelosbo”) and stop (e.g., END_dengissAelbairaVetelosbo”) of the Boolean declaration, as well as additional comments that mark the start (e.g., “//START_methidWithIfElse”) and stop (e.g., “//END_methodWithIfElse”) of first public method that is declared. Such comments provide context to the lines of code that reference the obsolete feature flag so that those lines of code can be more efficiently identified and more accurately refactored than lines of code that do not have additional context.

As shown in FIG. 6, tokenized file 606 (which may be an example of tokenized file 508 of FIG. 5) comprises a plurality of tokens that represent one or more lines of code from current source code 602 that reference the obsolete feature flag. For example, tokenized file 606 comprises token 607 (e.g., [dengissAelbairaVetelosbo]) that represents the line of code for the Boolean declaration for obsoleteVariableAssigned and token 609 (e.g., [methodWithIfElse]) that represents the related lines of code for the first public method declaration. In some aspects, each token corresponds to a line or a group of lines that is marked in context file 604 with additional comments (e.g., start and end labels). For example, a token could represent a first line code that comes after a start comment through a last line that comes before an end comment.

### Process Flowcharts for Generating Refactored Code Snippets

FIG. 7 depicts a process flowchart for using an LM to generate refactored code snippets based on a refactoring prompt and a context file segment identified from the source code that will be refactored.

For example, context file segment 702 (e.g., context file segment 214) and refactoring prompt 704 are provided as inputs to LM 706 (e.g., which may be an example of LM 218 of FIG. 2) to refactor a code snippet included in context file segment 702 to generate refactored source code snippet 708. Context file segment 702 is a segment extracted from context file 506. In particular, context file segment 702 is identified from context file 506 based on identifying source code snippet 320 in context file 506 and extracting a set of code lines that include source code snippet 320 and surround source code snippet 320 (e.g., context for source code snippet 320).

Refactoring prompt 704 comprises a set of instructions that will cause LM 706 to refactor the code snippet included in context file segment 702 according to target condition 705. An example of a refactoring prompt is described in more detail with respect to FIG. 8. Refactored source code snippet 708 is the refactored version of the code snippet included in context file segment 702 and reflects target condition 705 (e.g., omission of the obsolete feature flag).

FIG. 8 depicts an example of a refactored code snippet based on a context file segment and a refactoring prompt. Context file segment 802 (which may be an example of context file segment 702 of FIG. 7) comprises lines of code from source code snippet 320 of FIG. 3 along with additional comments marking the start and end of various groupings of code lines that reference the obsolete feature flag. Refactoring prompt 804 (which may be an example of refactoring prompt 704 of FIG. 7) comprises a set of instructions that will be used to guide an LM to perform the refactoring process. Refactoring prompt 804 can comprise generic instructions like:
“Refactor the code to remove the obsolete feature flag,” or more specific and detailed instructions like those depicted in FIG. 8. Such instructions can include explicit instructions to not delete comments that include a “START” or “END” tag and/or to delete all mentions of the obsolete feature flag name and corresponding code lines. Additional instructions can instruct an LM (e.g., LM 706 of FIG. 7) on how to handle different code lines based on the structure and/or outcome of different conditional statements, such as instructing the LM to keep certain lines if a value is returned as true and/or delete certain lines if a value returned is false. Beneficially, refactoring prompt 804 can be used to refactor all of the source code snippets, either in series, in batches, or in parallel, which have been identified as needing to be refactored, without having to modify the refactoring prompt 804 for specific source code snippets.

Refactored code snippet 806 has been refactored to omit the ability to execute logic statements that reference the obsolete feature flag. In some instances, such as shown in FIG. 8, refactored source code snippet 806 comprises commented out lines that reference the obsolete feature flag according to instructions included in refactoring prompt 804. Alternatively, those lines that reference the obsolete feature flag can be deleted entirely. Such instructions can be included in the refactoring prompt provided to the LM when generating the refactored source code. In either configuration, refactored source code snippet 902 can then be combined with a corresponding tokenized file to produce the final refactored source code.

### Process Flowcharts for Generating Final Refactored Source Code

FIG. 9 depicts a process flowchart for using a combiner to generate a final refactored source code based on the refactored source code snippet 902 and the tokenized file 904.

For example, refactored source code snippet 902 (which may be an example of refactored source code snippet 708 of FIG. 7) and tokenized file 904 (which may be an example of tokenized file 508 of FIG. 5) are provided to combiner 906 (which may be an example of combiner 222 of FIG. 2) to generate final refactored source code 908 (which may be an example of final refactored source code 224 of FIG. 2). Combiner 906 is configured to analyze refactored source code snippet 902 and identify the token in tokenized file 904 that corresponds to refactored source code snippet 902. The corresponding token is then deleted and replaced with refactored source code snippet 902. Comments that were added to the source code as part of the corresponding context file may also be deleted. Further detail is provided below with respect to FIG. 10.

For example, FIG. 10 depicts a detailed example of final refactored source code 1006 generated from a refactored source code snippet 1002 and a tokenized file 1004 that were combined. Final refactored source code 1006 (which may be an example of final refactored source code 908 of FIG. 9) is generated by inserting refactored source code snippet 1002 (which may be an example of refactored source code snippet 902 of FIG. 9) into tokenized file 1004 (which may be an example of tokenized file 904 of FIG. 9) in the place of one or more tokens included in tokenized file 1004. For example, the tokens [dengissAelbairaVetelosbo] and [methodWithIfElse] are replaced with refactored source code snippet 1002. Next, the code is cleaned to remove any comments such as START and/or END tags. In this manner, final refactored source code 1006 is the refactored version of source code snippet 320 of FIG. 3. In particular, whereas source code snippet 320 included references to the obsolete feature flag, final refactored source code 1006 does not have any references to the obsolete feature flag.

### Example Method for Automatically Refactoring Source Code

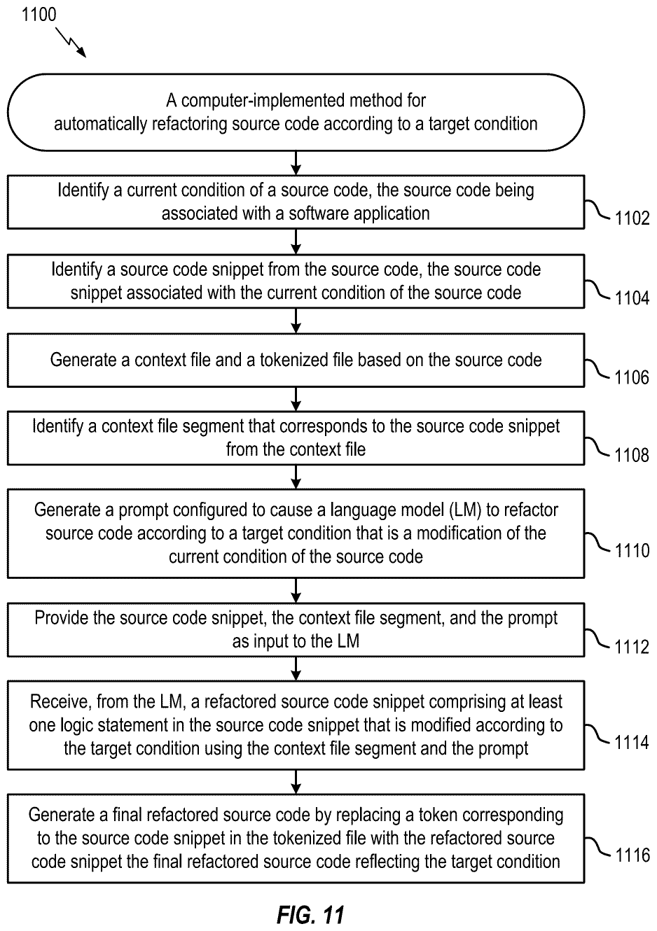

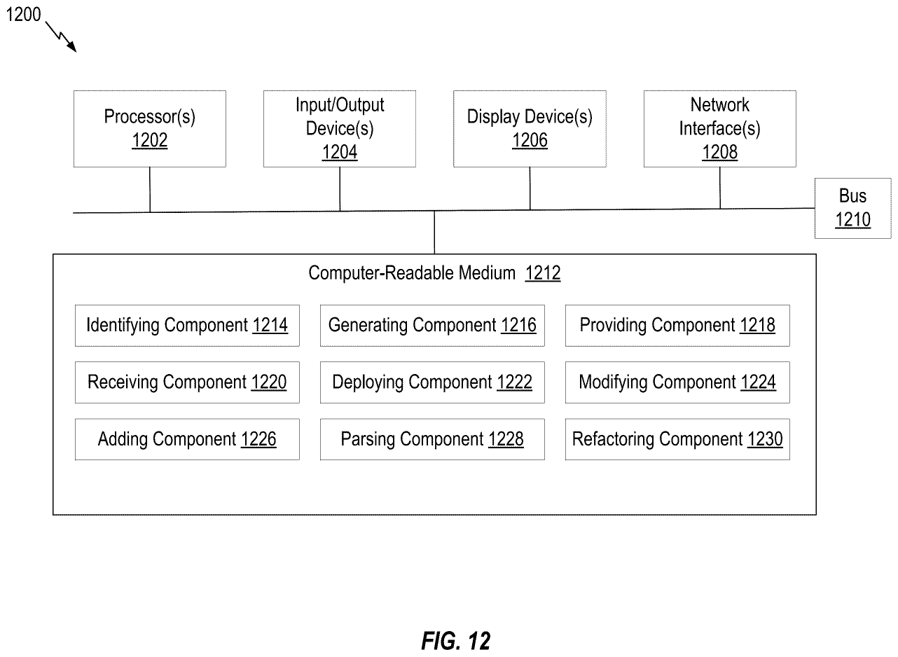

FIG. 11 depicts an example method 1100 for automatically refactoring source code according to a target condition. In one aspect, method 1100 can be implemented by the processing system 1200 of FIG. 12.

Method 1100 starts at block 1102 with identifying a current condition of a source code, the source code being associated with a software application. In some aspects, block 1102 is performed by identifying component 1214 of FIG. 12. By way of example, current condition 302 of FIG. 3 of source code 304 is identified using identifying component 1214.

Method 1100 continues to block 1104 with identifying a source code snippet, like source code snippet 320 of FIG. 3, from the source code, the source code snippet associated with the current condition of the source code.

Method 1100 continues to block 1106 with generating a context file and a tokenized file based on the source code. In some aspects, block 1106 is performed by generating component 1216 of FIG. 12. By way of example, generating component 1216 could generate context file 506 and tokenized file 508 of FIG. 5 based on the source code.

Method 1100 continues to block 1108 with identifying a context file segment, like context file segment 702 of FIG. 7, which corresponds to the source code snippet from the context file.

Method 1100 continues to block 1110 with generating a refactoring prompt configured to cause a language model (LM) to refactor source code according to a target condition that is a modification of the current condition of the source code. In some aspects, block 1110 is performed by generating component 1216 of FIG. 12. For example, generating component 1216 could generate refactoring prompt 704 configured to cause LM 706 of FIG. 7 to refactor source code according to a target condition 705. By generating a refactoring prompt in this manner, method 1100 overcomes the technical problem of flawed modification as part of the refactoring process by beneficially leveraging the understanding and generation capabilities of LMs because of specially configured inputs, like the refactoring prompt, to help prevent any hallucinations that might have been produced by the LM if conventional inputs had been used.

Method 1100 continues to block 1112 with providing the context file segment and the refactoring prompt as input to the LM. In some aspects, block 1112 is performed by providing component 1218 of FIG. 12. By generating a context file from the source code, specific portions of the context file are able to be identified as corresponding to a particular code snippet that needs to be refactored. By providing context such as code lines surrounding the particular code snippet and additional labels and notes that can be used by the LM, the LM is able to accurately modify the particular code snippet based on providing the context file segment of the context file corresponding to the code snippet and the refactoring prompt to the LM.

Method 1100 continues to block 1114 with receiving, from the LM, a refactored source code snippet comprising at least one logic statement in the source code snippet that is modified according to the target condition using the context file segment and the refactoring prompt. In some aspects, block 1114 is performed by receiving component 1220 of FIG. 12. By way of example, receiving component 1220 could receive refactored source code snippet 708 from the LM.

Method 1100 continues to block 1116 with generating a final refactored source code by replacing a token corresponding to the source code snippet in the tokenized file with the refactored source code snippet such that the final refactored source code reflects the target condition. For example, final refactored source code 1006 of FIG. 10 is generated by replacing token 1007 with refactored source code snippet 1002 or sub-snippet 1003.

Method 1100 thus also overcomes the technical problems arising from flawed integration of individual code snippets back into the source code files. By generating a tokenized file from the source code, each section of the source code is simplified to an individual token (e.g., label). This greatly reduces the memory required to store and processing resources required to process the source code file when identifying the correct location to integrate the newly refactored code snippet. Not only are computational resources reduced, the time is also reduced for finalizing the refactored source code files because it is easier and more efficient to identify a single token and replace the token with the newly refactored code snippet than search an entire source code file and identify all of the related lines of code that need to be replaced.

In some aspects, method 1100 further includes deploying the final refactored source code for the software application automatically during refactoring the source code or deploying the final refactored source code. In some aspects, deploying component 1222 of FIG. 12 is used to deploy the final refactored source code.

In some aspects, the tokenized file, such as tokenized file 606 of FIG. 6, comprises a plurality of tokens (e.g., token 607, token 609, etc. of FIG. 6), wherein each token corresponds to a different source code snippet of the source code.

In some aspects, the current condition comprises an obsolete feature flag, such as obsolete feature flag 403 of FIG. 4.

In some aspects, the source code snippet that is modified according to the target condition using the context file and the refactoring prompt is modified by removing one or more dependencies in the source code snippet related to the obsolete feature flag (such as described with respect to refactored source code snippet 806 of FIG. 8).

In some aspects, the target condition comprises presence of a new feature flag.

In some aspects, block 1114 includes modifying the at least one logic statement to include one or more dependencies related to the new feature flag. In some aspects, block 1114 is performed by modifying component 1224 of FIG. 12.

In some aspects, block 1114 includes generating and adding at least one new logic statement associated with the new feature flag. In some aspects, block 1114 is performed by adding component 1226 of FIG. 12.

In some aspects, the current condition comprises presence of a bug in the source code.

In some aspects, the current condition comprises presence of a redundancy in the source code.

In some aspects, the at least one logic statement is configured as an if-else statement, such as the If-Else statement 316 of FIG. 3.

In some aspects, block 1104 includes: parsing the source code into parsed code; generating an abstract syntax tree based on the parsed code; identifying one or more sets of logic statements that relate to the current condition of the source code within the abstract syntax tree; and identifying the source code snippet from the one or more sets of logic statements. By way of example, parsing component 1228 of FIG. 12 could parse source code 304 of FIG. 3 into parsed code 310. Generating component 1216 of FIG. 12 could generate abstract syntax tree 312 of FIG. 3 based on parsed code 310. Subsequently, identifying component 1214 of FIG. 12 could identify logic statements 314 of FIG. 3 that related to current condition 302. Identifying component 1214 could also be used to identify source code snippet 320 of FIG. 3 from logic statements 314.

By parsing the source code and utilizing an abstract syntax tree, method 1100 overcomes the technical problem of incomplete identification of code snippets related to the current condition, like the presence of an obsolete feature flag, which needs to be modified according to the target condition. This technical benefit is achieved by first converting the source code into an abstract syntax tree, wherein logic statements related to the current condition can be more accurately and efficiently identified. Furthermore, additional logic statements that are dependent on states of logic statements related to the current condition can also be quickly and easily identified because of the hierarchal nature of the abstract syntax tree which maps out dependencies between code snippets as interconnected nodes.

In some aspects, the source code is parsed using a language-specific parser, such as language-specific parser 308 of FIG. 3.

All of the aforementioned technical solutions beneficially prevent errors from being introduced into the final refactored source code. By preventing errors, aspects of the present disclosure are then able to prevent waste of computational resources that would have been needed to either compile or run the flawed source code and/or to fix the errors when in the process of deploying the refactored source code. Overall, by providing a more accurate refactored source code, the user experience and/or downstream applications interacting with the current application corresponding to the source code is uninterrupted.

Note that FIG. 11 is just one example of a method, and other methods including fewer, additional, or alternative operations are possible consistent with this disclosure.

### Example Processing System for Automatically Refactoring Source Code

FIG. 12 depicts an example processing system 1200 configured to perform various aspects described herein, including, for example, method 1100 as described above with respect to FIG. 11.

Processing system 1200 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 1200 includes one or more processors 1202, one or more input/output devices 1204, one or more display devices 1206, one or more network interfaces 1208 through which processing system 1200 is connected to one or more networks (e.g., a local network, an intranet, the Internet, or any other group of processing systems communicatively connected to each other), and computer-readable medium 1212. In the depicted example, the aforementioned components are coupled by a bus 1210, which may generally be configured for data exchange amongst the components. Bus 1210 may be representative of multiple buses, while only one is depicted for simplicity.

Processor(s) 1202 are generally configured to retrieve and execute instructions stored in one or more memories, including local memories like computer-readable medium 1212, as well as remote memories and data stores. Similarly, processor(s) 1202 are configured to store application data residing in local memories like the computer-readable medium 1212, as well as remote memories and data stores. More generally, bus 1210 is configured to transmit programming instructions and application data among the processor(s) 1202, display device(s) 1206, network interface(s) 1208, and/or computer-readable medium 1212. In certain embodiments, processor(s) 1202 are representative of a one or more central processing units (CPUs), graphics processing unit (GPUs), tensor processing unit (TPUs), accelerators, and other processing devices.

Input/output device(s) 1204 may include any device, mechanism, system, interactive display, and/or various other hardware and software components for communicating information between processing system 1200 and a user of processing system 1200. For example, input/output device(s) 1204 may include input hardware, such as a keyboard, touch screen, button, microphone, speaker, and/or other device for receiving inputs from the user and sending outputs to the user.

Display device(s) 1206 may generally include any sort of device configured to display data, information, graphics, user interface elements, and the like to a user. For example, display device(s) 1206 may include internal and external displays such as an internal display of a tablet computer or an external display for a server computer or a projector. Display device(s) 1206 may further include displays for devices, such as augmented, virtual, and/or extended reality devices. In various embodiments, display device(s) 1206 may be configured to display a graphical user interface.

Network interface(s) 1208 provide processing system 1200 with access to external networks and thereby to external processing systems. Network interface(s) 1208 can generally be any hardware and/or software capable of transmitting and/or receiving data via a wired or wireless network connection. Accordingly, network interface(s) 1208 can include a communication transceiver for sending and/or receiving any wired and/or wireless communication.

Computer-readable medium 1212 may be a volatile memory, such as a random access memory (RAM), or a nonvolatile memory, such as nonvolatile random access memory (NVRAM), or the like. In this example, computer-readable medium 1212 includes identifying component 1214, generating component 1216, providing component 1218, receiving component 1220, deploying component 1222, modifying component 1224, adding component 1226, and parsing component 1228. Processing of the components 1214-1228 may enable and cause the processing system 1200 to perform the method 1100 described with respect to FIG. 11, or any aspect related to it

In certain embodiments, identifying component 1214 is configured to identify a current condition of a source code, the source code being associated with a software application. In certain embodiments, identifying component 1214 is configured to identify a source code snippet from the source code, the source code snippet associated with the current condition of the source code. In certain embodiments, generating component 1216 is configured to generate a context file and a tokenized file based on the source code. In certain embodiments, identifying component 1214 is configured to identify a context file segment that corresponds to the source code snippet from the context file. In certain embodiments, generating component 1216 is configured to generate a refactoring prompt configured to cause a language model (LM) to refactor source code according to a target condition that is a modification of the current condition of the source code. In certain embodiments, providing component 1218 is configured to provide the source code snippet, the context file segment, and the refactoring prompt as input to the LM. In certain embodiments, receiving component 1220 is configured to receive, from the LM, a refactored source code snippet comprising at least one logic statement in the source code snippet that is modified according to the target condition using the context file segment and the refactoring prompt. In certain embodiments, generating component 1216 is configured to generate a final refactored source code by replacing a token corresponding to the source code snippet in the tokenized file with the refactored source code snippet the final refactored source code reflecting the target condition. In certain embodiments, deploying component 1222 is configured to deploy the final refactored source code for the software application automatically during refactoring the source code or deploying the final refactored source code.

Note that FIG. 12 is just one example of a processing system consistent with aspects described herein, and other processing systems having additional, alternative, or fewer components are possible consistent with this disclosure.

### Example Clauses

Implementation examples are described in the following numbered clauses:

Implementation examples are described in the following numbered clauses:
Clause 1: A computer-implemented method for automatically refactoring source code according to a target condition, comprising: identifying a current condition of a source code, the source code being associated with a software application; identifying a source code snippet from the source code, the source code snippet associated with the current condition of the source code; generating a context file and a tokenized file based on the source code; identifying a context file segment that corresponds to the source code snippet from the context file; generating a refactoring prompt configured to cause a language model (LM) to refactor source code according to a target condition that is a modification of the current condition of the source code; providing the context file segment and the refactoring prompt as input to the LM; receiving, from the LM, a refactored source code snippet comprising at least one logic statement in the source code snippet that is modified according to the target condition using the context file segment and the refactoring prompt; and generating a final refactored source code by replacing a token corresponding to the source code snippet in the tokenized file with the refactored source code snippet the final refactored source code reflecting the target condition.
Clause 2: The method of Clause 1, further comprising deploying the final refactored source code for the software application automatically during refactoring the source code or deploying the final refactored source code.
Clause 3: The method of any one of Clauses 1-2, wherein the tokenized file comprises a plurality of tokens, each token corresponding to a different source code snippet of the source code.
Clause 4: The method of any one of Clauses 1-3, wherein the current condition comprises an obsolete feature flag.
Clause 5: The method of Clause 4, wherein the source code snippet that is modified according to the target condition using the context file and the refactoring prompt is modified by removing one or more dependencies in the source code snippet related to the obsolete feature flag.
Clause 6: The method of any one of Clauses 1-5, wherein the target condition comprises presence of a new feature flag.
Clause 7: The method of Clause 6, wherein receiving the refactored source code snippet comprising at least one logic statement in the source code snippet that is modified according to the target condition using the context file and the refactoring prompt comprises modifying the at least one logic statement to include one or more dependencies related to the new feature flag.
Clause 8: The method of Clause 7, wherein receiving the refactored source code snippet comprising at least one logic statement in the source code snippet according to the target condition using the context file and the refactoring prompt comprises generating and adding at least one new logic statement associated with the new feature flag.
Clause 9: The method of any one of Clauses 1-8, wherein the current condition comprises presence of a bug in the source code.
Clause 10: The method of any one of Clauses 1-9, wherein the current condition comprises presence of a redundancy in the source code.
Clause 11: The method of any one of Clauses 1-10, wherein the at least one logic statement is configured as an if-else statement.
Clause 12: The method of any one of Clauses 1-10, wherein identifying the source code snippet associated with the current condition included in the source code comprises: parsing the source code into parsed code; generating an abstract syntax tree based on the parsed code; identifying one or more sets of logic statements that contribute to the current condition of the source code within the abstract syntax tree; and identifying the source code snippet from the one or more sets of logic statements.
Clause 13: The method of Clause 12, wherein the source code is parsed using a language-specific parser.
Clause 14: A processing system, comprising: memory comprising computer-executable instructions; and one or more processors configured to execute the computer-executable instructions and cause the processing system to perform a method in accordance with any one of Clauses 1-13.
Clause 15: A processing system, comprising means for performing a method in accordance with any one of Clauses 1-13.
Clause 16: A non-transitory computer-readable medium storing program code for causing a processing system to perform the steps of any one of Clauses 1-13.
Clause 17: A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for automatically refactoring source code according to a target condition, comprising:
identifying a current condition of a source code, the source code being associated with a software application;
identifying a source code snippet from the source code, the source code snippet associated with the current condition of the source code;
generating a context file and a tokenized file based on the source code;
identifying a context file segment that corresponds to the source code snippet from the context file;
generating a refactoring prompt configured to cause a language model (LM) to refactor source code according to a target condition that is a modification of the current condition of the source code;
providing the context file segment and the refactoring prompt as input to the LM;
receiving, from the LM, a refactored source code snippet comprising at least one logic statement in the source code snippet that is modified according to the target condition using the context file segment and the refactoring prompt; and
generating a final refactored source code by replacing a token corresponding to the source code snippet in the tokenized file with the refactored source code snippet the final refactored source code reflecting the target condition.

2. The computer-implemented method of claim 1, further comprising deploying the final refactored source code for the software application automatically during refactoring the source code or deploying the final refactored source code.

3. The computer-implemented method of claim 1, wherein the tokenized file comprises a plurality of tokens, each token corresponding to a different source code snippet of the source code.

4. The computer-implemented method of claim 1, wherein the current condition comprises an obsolete feature flag.

5. The computer-implemented method of claim 4, wherein the source code snippet that is modified according to the target condition using the context file and the refactoring prompt is modified by removing one or more dependencies in the source code snippet related to the obsolete feature flag.

6. The computer-implemented method of claim 1, wherein the target condition comprises presence of a new feature flag.

7. The computer-implemented method of claim 6, wherein receiving the refactored source code snippet comprising at least one logic statement in the source code snippet that is modified according to the target condition using the context file and the refactoring prompt comprises modifying the at least one logic statement to include one or more dependencies related to the new feature flag.

8. The computer-implemented method of claim 7, wherein receiving the refactored source code snippet comprising the at least one logic statement in the source code snippet according to the target condition using the context file and the refactoring prompt further comprises generating and adding at least one new logic statement associated with the new feature flag.

9. The computer-implemented method of claim 1, wherein the current condition comprises presence of a bug in the source code.

10. The computer-implemented method of claim 1, wherein the current condition comprises presence of a redundancy in the source code.

11. The computer-implemented method of claim 1, wherein the at least one logic statement is configured as an if-else statement.

12. The computer-implemented method of claim 1, wherein identifying the source code snippet associated with the current condition included in the source code comprises:
parsing the source code into parsed code;
generating an abstract syntax tree based on the parsed code;
identifying one or more sets of logic statements that contribute to the current condition of the source code within the abstract syntax tree; and
identifying the source code snippet from the one or more sets of logic statements.

13. The computer-implemented method of claim 12, wherein the source code is parsed using a language-specific parser.

14. A processing system, comprising: memory comprising computer-executable instructions; and one or more processors configured to execute the computer-executable instructions and cause the processing system to:
identify a current condition of a source code, the source code being associated with a software application;
identify a source code snippet from the source code, the source code snippet associated with the current condition of the source code;
generate a context file and a tokenized file based on the source code;
identify a context file segment that corresponds to the source code snippet from the context file;
generate a refactoring prompt configured to cause a language model (LM) to refactor source code according to a target condition that is a modification of the current condition of the source code;
provide the context file segment and the refactoring prompt as input to the LM;
receive, from the LM, a refactored source code snippet comprising at least one logic statement in the source code snippet that is modified according to the target condition using the context file segment and the refactoring prompt; and
generate a final refactored source code by replacing a token corresponding to the source code snippet in the tokenized file with the refactored source code snippet the final refactored source code reflecting the target condition.

15. The processing system of claim 14, wherein the one or more processors are configured to execute the computer-executable instructions and cause the processing system to deploy the final refactored source code for the software application automatically during refactoring the source code or deploying the final refactored source code.

16. The processing system of claim 14, wherein the tokenized file comprises a plurality of tokens, each token corresponding to a different source code snippet of the source code.

17. The processing system of claim 14, wherein the current condition comprises an obsolete feature flag.

18. The processing system of claim 14, wherein the source code snippet that is modified according to the target condition using the context file and the refactoring prompt is modified by removing one or more dependencies in the source code snippet related to the obsolete feature flag.

19. The processing system of claim 14, wherein the target condition comprises presence of a new feature flag.

20. The processing system of claim 14, wherein to cause the processing system to receive the refactored source code snippet comprising at least one logic statement in the source code snippet that is modified according to the target condition using the context file and the refactoring prompt, the one or more processors are configured to execute the computer-executable instructions and cause the processing system to modify the at least one logic statement to include one or more dependencies related to the new feature flag.
